(19) United States
(12) Patent Application Publication
(10) Pub. No.: US 2021/0307987 A1
(43) Pub. Date: Oct. 7, 2021

(54) Negative Pressure Isolation Pods

(71) Applicant: Holy Name Medical Center, Inc., Teaneck, NJ (US)

(72) Inventor: Steven Mosser, Long Valley, NJ (US)

(73) Assignee: Holy Name Medical Center, Inc., Teaneck, NJ (US)

(21) Appl. No.: 17/223,777

(22) Filed: Apr. 6, 2021

Related U.S. Application Data
(60) Provisional application No. 63/005,980, filed on Apr. 6, 2020.

(51) Int. Cl. A61G 10/00; A61G 10/02

(52) U.S. Cl. CPC A61G 10/005; A61G 10/023

(57) ABSTRACT

Negative pressure isolation devices are disclosed to remove exhaled air from patients and to vent such air to a filter or atmosphere to protect medical personnel and others.

### CROSS-REFERENCE TO RELATED APPLICATIONS

This application claims benefit of priority to U.S. Provisional Patent Application No. 63/005,980, filed Apr. 6, 2020, the entire disclosure of which is hereby expressly incorporated by reference.

### BACKGROUND

### Field of the Disclosure

The present disclosure relates to isolation apparatus and in particular, to negative pressure isolation apparatus for patients.

### Related Art

Negative room pressure is an isolation technique used in hospitals and medical centers to prevent airborne pathogens or contaminants from escaping a room. Generally, air is pulled from the negative pressure room into an adjoining space so that negative air pressure is created in the room. The air can then be filtered and/or exhausted to atmosphere outside the room. While negative pressure rooms generally prevent airborne contaminants and pathogens from escaping the room, caregivers who enter the room to attend to a patient can still be exposed to the airborne contaminants and pathogens. This is particularly problematic when dealing with patients afflicted with highly contagious infectious diseases that can be an aerosolized and expelled by the patient during treatment and when personal protective equipment (especially masks) are in short supply during a pandemic.

In the case of the COVID-19 virus, some evidence suggests that providing a patient with high-flow oxygen (e.g., 30-55 liters per minute) via a nasal cannula can increase the risk of aerosolization, whereas providing the patient with low-flow oxygen (e.g., 2-15 liters per minute) does not present as significant a risk. Accordingly, low-flow oxygen is provided to some patients who could otherwise benefit from high-flow oxygen, or patients are placed on a ventilator prematurely, as they are not able to receive high-flow oxygen.

In contrast to negative pressure rooms, positive pressure rooms maintain a higher pressure inside the treated area than that of the surrounding environment, so that germs, particles, and other potential pathogens or contaminants in the surrounding environment cannot enter the room. Positive pressure rooms are used for operating rooms and other sterile environments. However, positive pressure rooms, by design, can cause the escape of a highly contagious infectious disease.

### BRIEF DESCRIPTION OF THE DRAWINGS

The foregoing features of the disclosure will be apparent from the following Detailed Description, taken in connection with the accompanying drawings, in which:

FIG. 1 is a perspective view of a negative pressure isolation pod according to the present disclosure;

FIG. 2A is a front perspective view of another negative pressure isolation pod for use by an anesthesiologists in a positive pressure operating room according to the present disclosure;

FIG. 2B is a rear perspective view of the negative pressure isolation pod of FIG. 2A;

FIG. 3 is a perspective view of another negative pressure isolation pod for use when performing a C-section in a positive pressure room according to the present disclosure; and

FIG. 4 is a perspective view of a portable negative pressure isolation pod according to the present disclosure.

### DETAILED DESCRIPTION

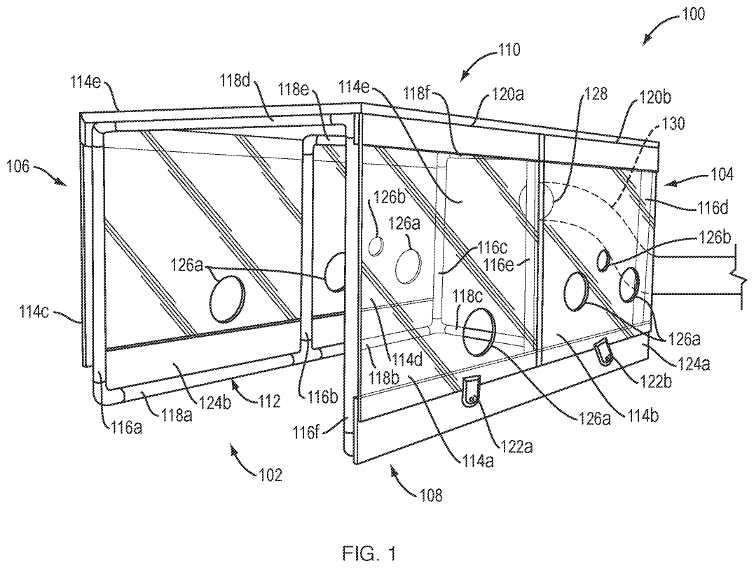

FIG. 1 is a perspective view of an isolation pod 100 according to the present disclosure. The isolation pod 100 shown in FIG. 1 can be configured as a free-standing structure that can be positioned over a patient that may be in a bed 102 located in a room of a medical facility, for example, in a negative pressure room. In use, the isolation pod 100 can be positioned over a patient in the bed 102, with a rear wall 104 of the isolation pod 100 being adjacent to the patient's head.

As shown in FIG. 1, the isolation pod can include a frame 112 or other support structure with a plurality of panels 114a-f (collectively, panels 114) secured thereto. The panels 114 can form left 106, right 108, rear 104, and top 110 sides of the isolation pod 100 that isolate the patient from a caregiver (e.g., doctor, nurse, staff, or the like) and the frame 112 can include a plurality of vertical support members 116a-f and a plurality of horizontal support members 118a-f joined together that provide support for the panels 114. For example, the frame 112 of the isolation pod 100 shown in FIG. 1 includes a number of vertical support members 116a-f and a number of horizontal support members 118a-f, as well as side panels 114a-d, top panel 114e, and rear panel 114f The support members of the frame can be formed from PVC tubing, or any other suitable material, and the panels can be formed from plexiglass, or any other suitable material. Additionally, the panels can be formed from marine vinyl, a clear, lightweight, and flexible heavy gauge vinyl material, or other material(s) with similar properties. The frame can also be formed from aluminum, or another lightweight and rigid material, to reduce the weight of the isolation pod 100 and facilitate transportation thereof. Furthermore, the frame of the isolation pod 100, as well as one or more of the panels attached thereto, can be configured to be collapsible for storage or for greater portability. Of course, the isolation pod 100 can be a free-standing unitary structure without a separate frame, for example, a generally transparent semi-cylindrical dome.

The left and right sides 106 and 108 of the isolation pod 100 can include one of more panels 114a-d (e.g., windows) through which the patient can be observed and can be configured to allow access to the patient by a caregiver. As such, a caregiver can start or adjust intravenous (“IV”) or oxygen treatments, examine patients, and provide other forms of care from outside of the isolation pod. According to some aspects of the present disclosure, permanent gloves—similar to those found in a pharmacy hood used for IV bag preparation, can also be provided in lieu of handhold openings. For example, as shown in FIG. 1, the one or more panels 114a-d can be secured to the frame 108 of the isolation pod 100 by a hinge 120, or other mechanism that allows for the temporary displacement, movement, or removal of the panels 114a-d. The isolation pod 100 can also be provided with one or more latches 122, or other mechanisms that prevent the panels 114a-d from being inadvertently displaced or removed. The latches 122 can be secured directly to the frame 112 and contact the window panels 114a-d, or the latches 122 can be secured to a window frame 124 at the bottom of the panels 114a-d, as shown in FIG. 1. Each of the panels 114a-d can include one or more apertures 126 for allowing access to the patient without requiring the panels 114a-d to be opened or removed. The apertures 126 can be provided in a plurality of different sizes and configurations, such as larger holes 126a sized to accommodate a caregiver's hands and smaller holes 126b sized to accommodate equipment such as tubing, wires, and the like. One or more panels 114e can be attached to the frame 112 to form the top side 110 of the enclosure. In a unitary structure, the isolation pod 100 can be semi-cylindrical, have portions of the sides that can rotate or move, and have apertures, to allow for patient access.

As shown in FIG. 1, one end of the isolation pod 100 (e.g., opposite to the rear side 104) can be at least partially open to accommodate a patient's legs and to allow air from the surrounding, e.g., negative pressure, room to be drawn into the isolation pod 100. The opening can be sized based on the volume of air that is being extracted from the room. For example, decreasing the size of the opening can increase the negative pressure of the isolation pod 100 relative to the rest of the pressure room. Conversely, increasing the size of the opening can decrease the negative pressure of the isolation pod 100 relative to the rest of the room. The rear side 104 of the isolation pod 100 can include a panel 114f having an aperture 128 that is coupled a conduit 130 (e.g., air duct) that can extend to an outlet where air is drawn out of the room to create the negative pressure in the room of the medical facility. Accordingly, air from the room is drawn into the isolation pod 100, flows past the patient and out through the conduit 130. As such, air flow is concentrated over the patient, and drawn out through the aperture 128 in the rear panel 114f of the isolation pod 100. Air flow over the patient can thereby be increased, for example, from 12-15 air exchanges per hour in a negative pressure room to, for example, over 300 air exchanges per hour within the isolation pod 100. The increased air flow within the isolation pod 100 increases the rate at which airborne contaminants and pathogens (e.g., an aerosolized virus expelled by the patient) are removed from the isolation pod 100 and the room. The increased air flow within the isolation pod 100 provides enhanced protection to the caregiver against airborne pathogens expelled by the patient. Furthermore, because the risks posed to the caregiver by the airborne pathogens expelled by the patient are minimized, patients suffering from respiratory ailments can be given high-flow oxygen, thereby enhancing the level of care provided to the patient while also protecting the caregiver from aerosolized pathogens.

The conduit 130 can be coupled to a HEPA filter (not shown) in order to remove the airborne contaminants and pathogens before the air is exhausted to atmosphere or recirculated. For example, according to some aspects of the present disclosure, commercial grade air scrubbers designed for construction sites can be used to generate the negative air flow for one or more negative pressure rooms, as these commercial air scrubbers can move 500-2,000 cubic feet of air per minute and are generally equipped with HEPA filters. According to other aspects of the present disclosure, the conduit 130 can be routed to the exterior of the building (e.g., through a sealed off window). According to still further aspects of the present disclosure, the conduit can be coupled to a restroom exhaust fan if no windows or other means for expelling the air from the negative pressure room is available.

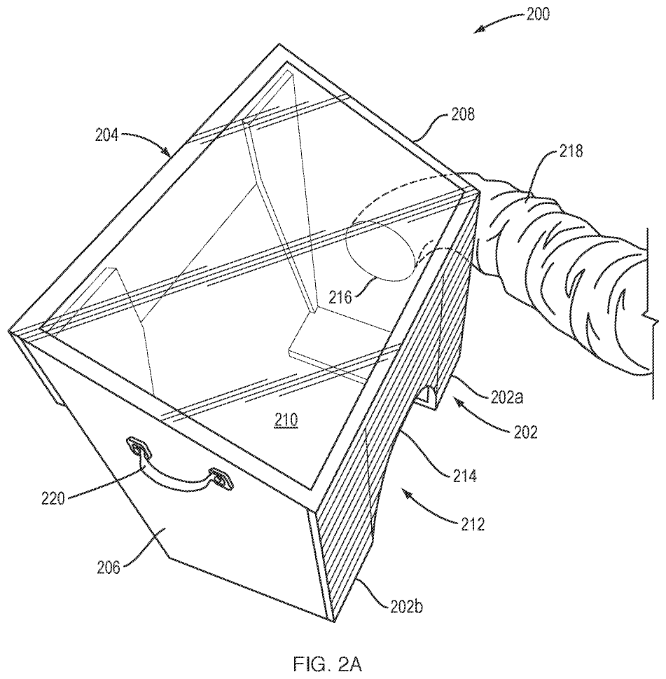

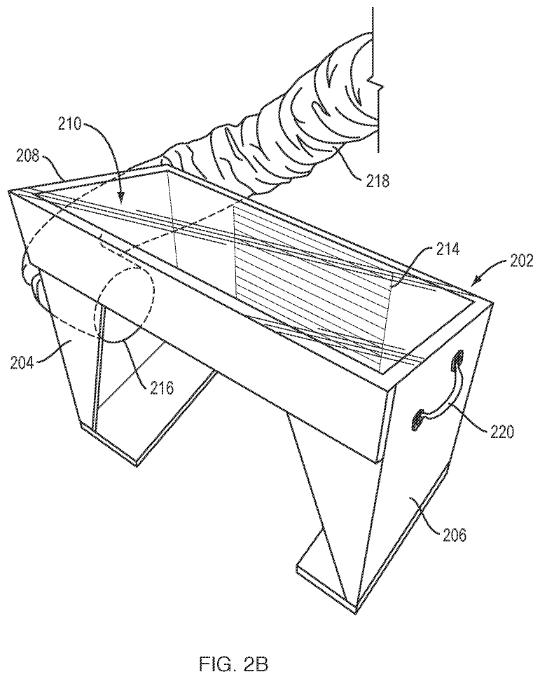

FIG. 2A is a front perspective view of another isolation pod 200 according to the present disclosure and FIG. 2B is a rear perspective view of the isolation pod 200. FIGS. 2A and 2B are referred to jointly herein. The isolation pod 200 shown in FIGS. 2A and 2B can function similar to the isolation pod 100 described in connection with FIG. 1, namely, increasing the rate of air exchanges within the isolation pod 200 by concentrating negative air flow, thereby increasing the rate at which airborne pathogens expelled by the patient are removed from the isolation pod 200.

The isolation pod 200 can be configured as free-standing structure that can be positioned over a patient's head during a medical procedure. For example, the isolation pod 200 can be positioned over a patient's head in an operating room of a medical facility while undergoing an intubation procedure. As shown, the isolation pod 200 can include a front wall 202, a rear wall 204, a left side wall 206, a right side wall 208, and a top window 210. The front wall 202 can be formed from one or more pieces 202a and 202b and cam be provided with a central aperture 212 having a width sized to accommodate a patient's head and neck. A transparent skirt 214 can be attached to the front side 202 of the isolation pod 200 and can be configured to reduce the area of the aperture 212, thereby concentrating negative air flow in an area directly adjacent to the patient's head during the procedure. However, the skirt 214 can be displaced in the event that access is needed to the patient's head from the front side 202 of the isolation pod 200—typically required when intubating or extubating a patient. The height of the rear wall 204 can be greater than that of the front wall and can be generally open to the surrounding environment, in order to provide a caregiver unobstructed access to the patient's head during a procedure (e.g., intubation). One or more of the sidewalls 206 and 208 (e.g., the right side wall 208 as shown in FIG. 2A) can be provided with an aperture 216 for connection to a conduit 218, through which air is drawn to create the negative pressure in the isolation pod 200. Additionally, the sidewalls 206 and 208 can be provided with handles 220 in order to facilitate rapid deployment and removal of the isolation pod 200.

The isolation pod 200 can be coupled to either a centralized, or dedicated, air mover (not shown). For example, the conduit 218 can be attached to the isolation pod 200 at a first end thereof and attached to the air mover at an opposite end thereof. The air mover can be a fan or other air moving device and it can have, or be coupled to, a filter (e.g., a HEPA filter) or an air scrubber, or it can be vented to atmosphere outside a building.

The walls of the isolation pod 200 can be formed from PVC, plywood, or any other suitable material that can provide the required strength, rigidity, and washability to support the structure of the isolation pod, and the windows can be formed from plexiglass, or any other suitable material. For example, the walls can also be formed from aluminum, or another lightweight and rigid material, to reduce the weight of the isolation pod 200 and facilitate transportation thereof. Furthermore, the walls of the isolation pod 200 can be configured to be collapsible for storage or for greater portability. According to some aspects of the present disclosure, the entire isolation pod 200 can be made of a clear plexiglass of unitary construction, for complete visibility. The walls and/or windows can also be formed from marine vinyl, a clear, lightweight, and flexible heavy gauge vinyl material, or other material(s) with similar properties, reducing the weight of the isolation pod 200 and facilitating transportation thereof. The skirt can be formed from any material, or combination of materials, that is flexible to accommodate a patient.

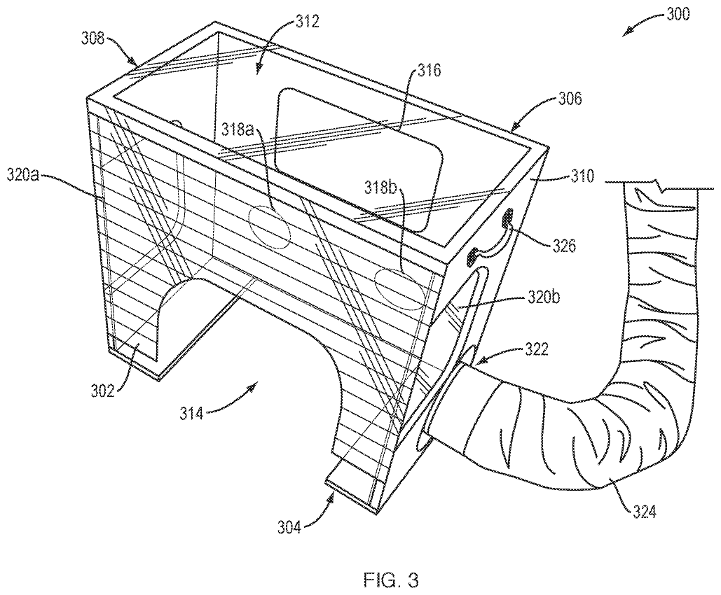

FIG. 3 is a front perspective view of another isolation pod 300 according to the present disclosure. The isolation pod 300 shown in FIG. 3 can function similar to the isolation pods 100 and 200 described in connection with FIGS. 1-2B, namely, increasing the rate of air exchange within the isolation pod 300 by concentrating negative air flow, thereby increasing the rate at which airborne pathogens expelled by the patient are removed from the isolation pod 300 without allowing same to travel in or through a room.

The isolation pod 300 can be configured as free-standing structure that can be positioned over a patient's head during a medical procedure. For example, the isolation pod 300 can be positioned over a patient's head in a delivery room of a medical facility while a patient is undergoing a Cesarean section (or C-section). As shown, the isolation pod 300 can include a skirt 302 attached to a front wall 304, a rear wall 306, a left side wall 308, a right side wall 310, and a top window 312. The skirt 302 can be attached to the front side 304 of the isolation pod 300 and can include an aperture 314 sized to accept a patient's head and neck. The skirt 302 can be flexible to accommodate a patient and it can be displaced in the event that access is needed to the patient's head from the front side of the isolation pod 300. As shown, the rear wall 306 can include a window 316 and one or more apertures 318a and 318b for providing a caregiver access to the interior of the isolation pod 300, for example, to access an emesis bag. The sidewalls 308 and 310 can also be provided with one or more windows 320a and 320b for observing the patient. One or more of the sidewalls 308 and 310 (e.g., the right side wall 310 as shown in FIG. 3) can be provided with an aperture 322 for connection to a conduit 324, through which air is drawn to create the negative pressure in the isolation pod 300, thereby concentrating negative air flow in an area directly adjacent to the patient's head during the procedure. Additionally, the sidewalls 308 and 310 can be provided with one or more handles 326 in order to facilitate rapid deployment and removal of the isolation pod.

The isolation pod 300 can be coupled to either a centralized, or dedicated, air mover (not shown). For example, the conduit 324 can be attached to the isolation pod 300 at a first end thereof and attached to the air mover at an opposite end thereof. The air mover can be a fan or other air moving device and it can have, or be coupled to, a filter (e.g., a HEPA filter) or an air scrubber, or it can be vented to atmosphere outside a building.

The walls 304-310 of the isolation pod can be formed from plywood, particle board, PVC, or other suitable material, the windows can be formed from plexiglass, or other suitable material, and the skirt can be formed from any suitable material, or combination of materials. According to some aspects of the present disclosure, the isolation pod 300 can be a unitary structure, such as a dome or semi-cylindrical structure, and can be formed from a transparent material (e.g., plexiglass). Additionally, the walls of the isolation pod 300 can be formed from marine vinyl, a clear, lightweight, and flexible heavy gauge vinyl material, or other material(s) with similar properties, reducing the weight of the isolation pod 300 and facilitating transportation thereof. Furthermore, the frame of the isolation pod 100, as well as one or more of the panels attached thereto, can be configured to be collapsible for storage or for greater portability.

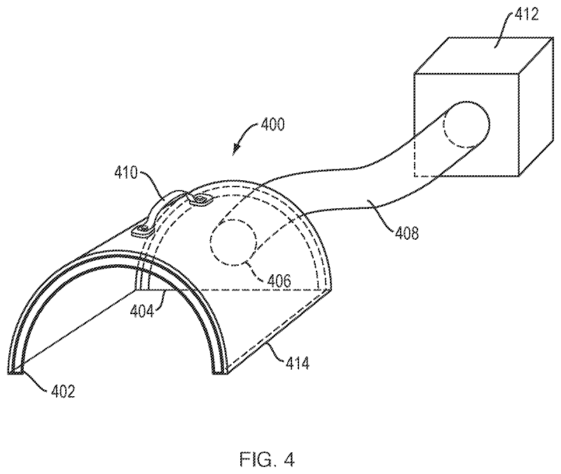

FIG. 4 is a perspective view of a portable isolation pod 400 according to the present disclosure. The isolation pod 400 shown in FIG. 4 can function similar to the isolation pods 100, 200, and 300 described in connection with FIGS. 1-3, namely, increasing the rate of air exchange within the isolation pod 400 by concentrating negative air flow, thereby increasing the rate at which airborne pathogens expelled by the patient are removed from the isolation pod 400 without allowing same to travel in or through a room.

The isolation pod 400 can be configured as free-standing structure that can be transported to a patient's location, or transported along with a patient, and positioned over the patient's head to protect caregivers from airborne pathogens expelled by the patient. As shown, the isolation pod 400 can include a tubular frame 402, semi-cylindrical walls 414 that are secured to the frame 402, and a semicircular rear wall 404 that is also attached to the frame 402. The isolation pod 400 can be sized to cover a patient's head and neck, in order to enhance mobility. The rear wall 404 of the isolation pod can include an aperture 406 for connection to a conduit 408, through which air is drawn to create the negative pressure in the isolation pod 400, thereby concentrating negative air flow in an area directly adjacent to the patient's head. Additionally, the isolation pod 400 can be provided with one or more handles 410 in order to facilitate rapid deployment and removal of the isolation pod 400. The semi-cylindrical walls 414 and rear wall 404 of the isolation pod 400 can be formed from plexiglass, or other transparent material. The walls of the isolation pod 400 can also be formed from marine vinyl, a clear, lightweight, and flexible vinyl material or other material(s) with similar properties, and frame can be formed from aluminum, or another lightweight and rigid material, reducing the weight of the isolation pod 400 and facilitating transportation thereof. According to some aspects of the present disclosure, the isolation pod 400 can be a unitary structure formed entirely from a transparent material (e.g., plexiglass).

Isolation pod 400 can also be coupled to a dedicated air mover 412. For example, as shown in FIG. 4, the conduit 408 can be attached to the isolation pod 400 at a first end thereof and attached to the air mover 412 at an opposite end thereof. The air mover 412 can be a fan or other air moving device and it can have, or be coupled to, a filter (e.g., a HEPA filter) or an air scrubber, or it can be vented to atmosphere outside a building. As such, the isolation pod 400 can be transported to any location where it is needed. Additionally, the air mover 412 can be provided with a dedicated power supply (e.g., a battery) to make it completely mobile. As such, the isolation pod 400 can be transported along with a patient, for example, as the patient is being moved from a negative pressure room to an operating room, thereby protecting caregivers with enhanced protection from airborne pathogens at all times during transport of the patient.

The isolation pods described in connection with FIGS. 2A-4 can be used to provide local negative pressure within an environmental system that provides positive pressure, such as in operating rooms that are kept at positive pressure to prevent germs, particles, and other potential contaminants in the surrounding environment from entering the operating room.

For example, according to some aspects of the present disclosure, a 500 cubic feet of air per minute scrubber can be coupled to an opposite end of the conduit and the exhaust from the scrubber can be routed to preexisting floor returns in the operating room. Accordingly, the isolation pods can generate a negative pressure environment surrounding a patient's head, within a positive pressure room, thereby protecting the patient from external contaminants while also protecting caregivers from airborne pathogens expelled by the patient.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

What is claimed is:

1. A partial enclosure for a patient comprising:
a top wall;
opposing side walls depending from the top wall;
an end wall depending from the top wall and interconnected with the opposing side walls;
an open area for accommodating a patient and allowing air flow; and
a negative pressure air aperture connected to an air exhaust;
wherein air is drawn into the enclosure, past a patient's face, and out through the negative pressure air aperture to the air exhaust.

2. The apparatus of claim 1, further comprising a plurality of apertures in the enclosure walls to allow a medical provider to access the patient.

3. The apparatus of claim 2, wherein the apertures are different sizes to permit access to a patient by medical personnel and tubes to pass into the enclosure.

4. The apparatus of claim 1, further comprising a frame including horizontal and vertical support members.

5. The apparatus of claim 1, wherein the one or more walls can be opened to permit access to the patient.

6. The apparatus of claim 2, further comprising permanent gloves at one or more of the plurality of apertures.

7. The apparatus of claim 1, wherein air flow is adjustable.

8. The apparatus of claim 1, wherein the air drawn through the negative air aperture is exhausted to atmosphere.

9. The apparatus of claim 1, wherein the air exhaust passes through a HEPA filter before recirculation.

10. The apparatus of claim 1, wherein the enclosure is transparent.

11. The apparatus of claim 1, wherein a portion of the enclosure is transparent.

12. The apparatus of claim 1, wherein the open area is sized to accommodate a patient's neck.

13. The apparatus of claim 12, wherein a skirt can reduce the size of the opening.

14. The apparatus of claim 1, wherein the air exhaust is on the end wall.

15. The apparatus of claim 1, wherein the air exhaust is on a side wall.

16. The apparatus of claim 1, further comprising an air mover.

17. The apparatus of claim 16, further comprising an air filter.

18. The apparatus of claim 17, wherein the air mover is powered by a battery.

19. The apparatus of claim 1, wherein one or more of the top, side, and end walls are formed from marine vinyl.

20. The apparatus of claim 1, comprising a collapsible fame supporting the top, side, and end walls.

21. The apparatus of claim 20, wherein the collapsible fame is formed from aluminum.

22. A partial enclosure for a patient comprising:
an upper area;
side areas extending about the head and sides of a patient;
an open area for accommodating a patient and allowing air flow; and
a negative pressure air aperture connected to an air exhaust of the enclosure;
an air flow path extending from outside of the enclosure, into the open area, past a patient's head and face, and through the negative pressure air aperture to the air exhaust.

23. The apparatus of claim 22, wherein the upper area and side areas are formed of vinyl.

24. The apparatus of claim 23, comprising a collapsible fame supporting the upper area and side areas.

25. A partial enclosure for a patient comprising:
a top wall;
opposing side walls depending from the top wall;
a partial end wall depending from the top wall and interconnected with the opposing side walls;
a neck area for accommodating a patient; and
a negative pressure air aperture connected to an air exhaust;
wherein air is drawn into the enclosure, past a patient's face, and out through the negative pressure air aperture to the air exhaust.
